(19) United States
(12) Patent Application Publication
(10) Pub. No.: US 2010/0068087 A1
(43) Pub. Date: Mar. 18, 2010

(54) METHODS AND APPARATUS FOR MIXING POWDERY SUBSTANCES, PARTICULARLY FOR MANUFACTURE OF METAL MATRIX COMPOSITE (MMC) MATERIALS

(76) Inventor: John James Saveker, Birmingham (GB)

Correspondence Address: Pabst Patent Group LLP, 1545 PEACHTREE STREET NE, SUITE 320, ATLANTA, GA, 30309, US

(21) Appl. No.: 12/377,131

(22) PCT Filed: Aug. 8, 2007
(86) PCT No.: PCT/IB07/02285

§ 371 Date: Feb. 11, 2009

(30) Foreign Application Priority Data
Aug. 11, 2006 (GB) 0615981.8

(51) Int. Cl. B22F 1/00; B01F 3/18; B01F 13/00; B01F 15/06; B22F 3/12

(52) U.S. Cl. 419/10; 366/343; 366/139; 366/219

(57) ABSTRACT

A blender apparatus (10) comprises an electric motor (11) driving a shaft (12) through a gear box (13). The shaft at a region (14) passes through an upright member (15) of the support structure (16). The shaft at region (14) passes through the upright member by means of a bush or bearing (not shown) suitable to facilitate rotation of the shaft. The rotation of the shaft further drives the holder (17) that is fixable mounted to the shaft such that holder 17 rotates-with the shaft. A powder container (18) is mounted on the holder and secured by a suitable attachment device (19) to ensure that the powder container rotates with the holder during operation. Suitable attachment devices could include a clamping device or a simple elastic strap. The required quantities of metallic and non-metallic powders are poured into the opening (20) in container (18). The body of powder (21) is then sealed into container (18) with a suitable seal (22) before the container is mounted in the holder.

The present invention relates to a method of mixing powders or particulate materials, in particular, although not exclusively, to mixing a metal powder with a non-metallic powder such as a ceramic powder and also to a material manufactured by such a method and to apparatus useful in such methods.

Mixing of metallic powders with ceramic powders is common practice in powder metallurgy and is done on an industrial scale in blending apparatus such as Y-cone blenders, Ribbon Blade mixers and simple tumblers that rotate around an axis whilst gently manoeuvring the powder from one end to the other.

When powders of dissimilar materials, for example a metal and a ceramic, are mixed, problems are often encountered with separation of the materials; the lower density powder will often rise to the top or agglomeration of the powder may be seen, particularly with very fine ceramic powders.

One area where metal and ceramic materials are usefully combined is in the manufacture of metal matrix composite (MMC) materials. The addition of ceramic particulates to the metal matrix is one form of MMC, often known as MMCp. However, if the mechanical property benefits of the MMCp material are to be optimised it is important to have a uniform distribution of ceramic particulates throughout the metal matrix and to minimise the number of touching particles and regions where particles may agglomerate.

The low cost, stir-casting method of adding particles to a matrix material, such as an aluminium alloy in the molten state, produces a low quality MMC with a poor particle distribution and regions where ceramic particles are clumped or agglomerated. Such materials show limited benefits in terms of their mechanical properties when compared with conventional alloys. Furthermore, the formability of the materials can be inferior when formed by processes such as forging and extrusion.

Higher quality particulate MMC, or MMCp, can be produced by the process of to mechanical alloying.

EP 0240251 describes a process for the mechanical alloying of aluminium powders with fine silicon carbide (SiC) which uses a high energy milling process to produce an intimate mixture of the fine SiC particles embedded in aluminium alloy particles. The blended material is subsequently loaded into an aluminium can before being degassed and sealed. The material is then consolidated in the can by Hot Isostatic Pressing (HIP). The MMCp material produced by this mechanical alloying route has improved fatigue resistance, modulus and ultimate tensile stress compared with the unreinforced aluminium alloy.

The mechanical alloying process, such as that disclosed above, produces material that is relatively expensive compared with conventional alloys. In addition, mechanical alloying is known to produce small amounts of contamination from wear of the materials used in the blending mill. Such contamination is difficult to control and is detrimental to material properties, in particular crack propagation and fatigue resistance.

Accordingly, there is a need for a low cost method of blending dissimilar materials, such as powders for example metallic and non-metallic particles, to produce a mixture with a substantially uniform distribution of one material within the other, e.g. non-metallic particles, in metallic particles, that is, preferably, free from contamination. Such a blend, for example of metallic and non-metallic particles, would be suitable for further processing to consolidate the particulates to, say, manufacture MMCp material capable of application in products and markets where high quality standards are required.

Accordingly, a first aspect of the invention provides a method of mixing two non-identical powder or particulate materials together for the substantially homogeneous distribution of one material within the other, the method comprising locating quantities of each material in an electrically insulating vessel and agitating the vessel for a period of time.

Preferably the two materials comprise metallic particles and non-metallic particles respectively. The non-metallic particles may comprise or consist of ceramic material.

Preferably the metallic particles are present in a major proportion.

A second aspect of the invention provides a low energy method of mixing metallic and non-metallic particulate materials for the substantially homogeneous distribution of one material throughout the other, the method comprising locating quantities of each material into a vessel comprising an electrically insulating material and agitating the vessel for a period of time.

The vessel may be agitated by rotating the vessel. Preferably the vessel has a major axis and it is rotated such that the axis has a vector component in the vertical.

The speed of rotation of the powder container can be within a wide band. However, to optimise the speed of mixing a rotational speed in the region of 3 to 60 rpm is suggested, with the preferred rotational speed being in the range 10 to 30 rpm.

The volume of powder in the container is selected to allow sufficient space for the powder to mix in the container. Preferably the volume of powder in the container should be less than 60% of the container volume, better, less than 40% of the volume of the container volume, and most preferred 15 to 30% of the volume of the container. Of course lower, higher or intermediate of the most preferred range of values may be used.

In this specification the term ‘low energy’ is intended to refer to the use of sufficient energy to cause agitation of a vessel, e.g. by rotating the vessel, shaking the vessel or otherwise causing the so-contained materials-to move within the vessel and in addition or alternatively, refers to a process of mixing which uses less energy than the process disclosed in EP 0240251.

A third aspect of the invention provides a method of forming an MMC or MMCp material, the method comprising locating quantities of a metal particulate material and a ceramic particulate material in an electrically insulating vessel, agitating the vessel for a period of time to mix the two materials, placing the mixed materials in a deformable vessel and subjecting the vessel to temperature and pressure to consolidate the mixed materials.

A further aspect of the invention provides apparatus for providing a substantially homogeneous distribution of one particulate material within another, the apparatus comprising vessel holding means and a vessel having an electrically insulating inner surface in which quantities of each material are locatable the vessel being retainable by said vessel holding means and means for agitating the vessel for a period of time.

In a more specific aspect of the invention there is described a method of blending metallic and non-metallic powders whereby the powder particles are mixed by a simple tumbling action within a vessel that is made of an electrically insulating material. Examples of suitable materials for the vessel are glass or plastics such as Perspex. Although both of these example materials are transparent, transparency is not a required feature and the invention would work equally well in a blender made out of an opaque material as long as the vessel is electrically insulating.

The vessel could be made of a metal and coated inside with an electrically insulating coating. This could be done by, for example, coating the inside of a steel vessel with glass. This would give the vessel more resistance to external damage than would be the case if the vessel were made entirely of glass.

The use of an electrically insulating container for blending the powders results in a mixture of powders having a substantially uniform distribution of ceramic particles around and throughout the metal particles. This mixture is not prone to segregation when left to stand in the electrically insulating container for a period of time up to several days. The ratio of metallic to ceramic particles is dependent on the relative volumes required in the blend and the relative particle sizes selected.

The method of blending powders is found to work with a wide range of materials and compositions. Examples that have been successfully blended include additions of 0.2% Zirconia (ZrO₂) to ASP30 grade steel powder and additions of 25% silicon carbide (SiC) to aluminium alloy.

Although the mechanism causing the powders to blend to such a uniform mixture is not completely understood, and although we do not wish to intend to be bound by any particular theory it is believed that, as it only works in an electrically insulating container, the agitation, e.g. the tumbling, of the metallic and ceramic powders within the container creates opposing electrostatic charges on each type of particle. If, for example, the metallic particles become positively charged, then the ceramic particles become negatively charged and vice versa. The body of blended powder is, overall, charge neutral. The opposing charge states of the metallic and ceramic particles causes an attraction between them, resulting in the ceramic powder particles being attached to and surrounding the metal powder particles and thereby being substantially uniformly distributed throughout the metallic powder particles.

In order that the invention may be well understood it will now be described by way of illustration only with reference to the accompanying diagrammatic drawings in which:

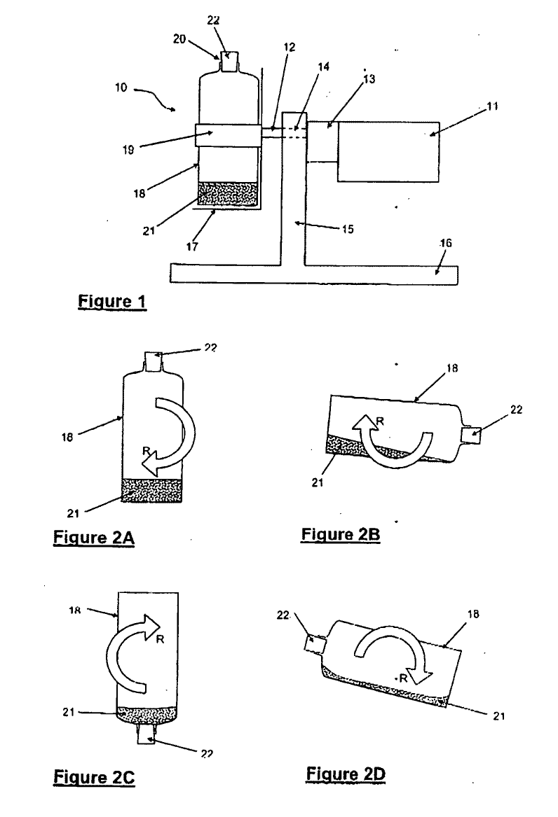

FIG. 1 provides a schematic drawing of a blender according to the invention.

FIGS. 2A to 2D provide a diagrammatic representation of the rotation action of the blender of FIG. 1.

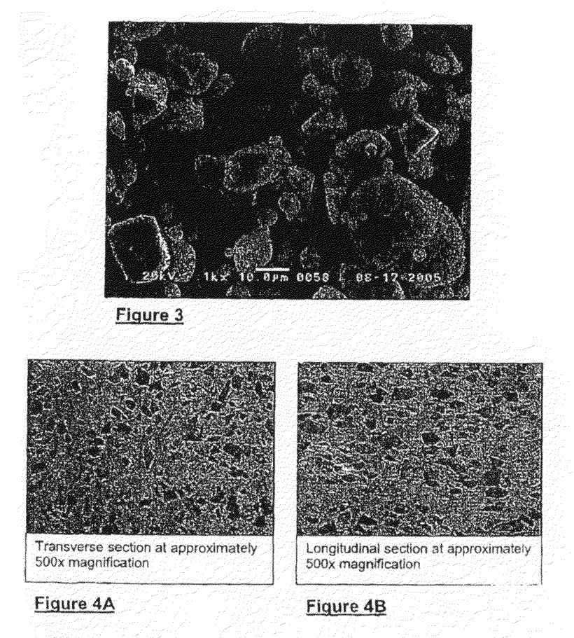

FIG. 3 is an SEM micrograph of powder blend showing ceramic particles distributed through metal powder.

FIGS. 4A and 4B provide micrograph of Aluminium—SiC MMC extrusion made in accordance with the invention along transverse (FIG. 4A) and longitudinal (FIG. 4B) sections.

A blender apparatus 10 comprises an electric motor 11 driving a shaft 12 through a gear box 13. The shaft 12 at a region 14 passes through an upright member 15 of the support structure 16. The shaft 12 at region 14 passes through the upright member 15 by means of a bush or bearing (not shown) suitable to facilitate rotation of the shaft 12. The rotation of the shaft 12 further drives the holder 17 that is fixably mounted to the shaft 12 such that holder 17 rotates with the shaft.

A powder container 18 is mounted on the holder 17 and secured by a suitable attachment device 19 to ensure that the powder container 18 rotates with the holder 17 during operation. Suitable attachment devices 19 could include a clamping device or a simple elastic strap.

The required quantities of metallic and non-metallic powders are poured into the opening 20 in container 18. The body of powder 21 is then sealed into container 18 with a suitable seal 22 before the container is mounted in the holder 17. The seal 22 can be a simple rubber or cork stopper of a suitable size for the opening 20. Alternatively, the seal 22 could be attached to the container 18 by other suitable means such as a thread engagement.

Container 18 is made of a material that is electrically insulating. One material that has been successfully used for this application is glass, as well as being suitable to effect mixing according to the invention a further advantage of glass for the mixing container 18 is the powders can be mixed without picking up the contamination that is known to occur in other mixing methods for achieving a uniform distribution of non-metallic powder in a metallic powder, such as mechanical alloying.

The rotation of the shaft causes the powder container 18 to rotate about a point in axial alignment with the centre of shaft 12. The rotation of container 18 causes the powders 21 to tumble from one end of the container to the other with a gentle action that does not result in any heating of the powder.

The rotating action is shown in FIG. 2 parts A to D. The powder container 18, containing a body of powder 21 and sealed by sealing means 22, is rotated in a clockwise direction as indicated by arrow R. The mixing action would be equally effective if the direction of rotation were in the counter-clockwise direction.

As the powders 21 tumble from one end of the container to the other they become intermixed until there is a uniform distribution of non-metallic powder particles through the metallic powder particles.

Although the apparatus illustrated in FIG. 1 shows a single powder-mixing container 18 being driven to rotate by a single motor unit 11 it will be appreciated that the apparatus can be designed with multiple holders 17 and powder containers 18 driven by one motor unit. This can be achieved by the use of a simple mechanical coupling such as a system of gears or a chain drive from the motor to each container holder.

FIG. 3 shows an SEM photomicrograph of blended aluminium and silicon carbide powder particles. This blend consisted of 75% by volume of aluminium alloy powder particles with an average size of 30 μm, with a wide spread in particle sizes, and 25% by volume of SiC powder with an average particle size of 12.8 μm. The ratio of the number of aluminium alloy particles to SiC particles is 1:4. The micrograph shows substantially uniform distribution of SiC articles throughout the aluminium alloy particles. The aluminium alloy particles are generally spherical and, although the average particle size is 30 μm, there is a wide distribution in particle sizes. The SiC particles are generally of a more angular shape.

A mixture of metallic and ceramic particles can usefully be consolidated into a metal matrix composite (MMC). The consolidation can be achieved by loading a powder blend of the required composition into a suitable can of deformable material, degassing the mixture under vacuum to remove all impurities from the container and powder blend, sealing the can and subjecting the can and powder contents to Hot Isostatic Pressing (HIP) under conditions suitable to consolidate the powder blend. After removal from the HIP apparatus the can is removed or machined away to leave the consolidated MMC material. The resulting MMC material has a substantially uniform distribution of ceramic particles throughout the metal matrix material with no agglomeration of the ceramic particles. The MMC can then be processed to the required component shape by machining, forging, extrusion or other manufacturing operation or combination of operations.

### EXAMPLE 1

1 kg of aluminium alloy powder, grade 2124, is loaded into a glass vessel with a capacity of 4.5 litres. A further 385 g of SiC powder is then added into the vessel. The aluminium powder was a commercially available 2124 alloy grade with a d₅₀ (mean) particle size of 30 μm. The SiC powder had a d₅₀ particle size of 12.8 μm. The proportion of SiC is equivalent to 25% by volume. In total, powders filled the vessel to approximately 30% of its capacity.

The vessel was sealed with a rubber bung and attached to a holder on the mixing apparatus by means of a strap that holds the vessel firmly in place during rotation. The mixing apparatus had a capacity to rotate 8 vessels, arranged as 4 pairs of vessels with one on each side of a frame structure. The vessel holders for each pair were Joined by a shaft incorporating a sprocket fixed to the shaft and driven by a chain from the motor to cause each shaft, and hence each pair of vessels, to rotate at a speed of 18 rpm. This arrangement causes half of the powder vessels to rotate in a clockwise direction and half to rotate in a counter-clockwise direction.

The powders were mixed in the vessel for a total of 30 minutes, after which time the vessel was removed from the holder. The powder blend was then poured from the can into an aluminium can with diameter of 190 mm. This process was repeated until the can held a total of 11 kg of blended powder. A short period of vibration was used to improve the fill density of the can in order to realise a packing density of 60-70% of theoretical density.

The can and powder blend was degassed under vacuum and temperature known in the art until a vacuum of between 10⁻³ and 10⁻² mbar was maintained. The can was then sealed to prevent the ingress of contaminants ready for HIP at temperature and pressure conditions known in the art, and held at temperature for a duration of at least 1 hour.

After HIP the can was removed from the HIP vessel and then the aluminium can material was removed by machining to leave a consolidated billet of MMCp material with a diameter of 154 mm and length of 175 mm.

The MMCp billets had densities between 2.88±0.1 gcm⁻³ and 2.89±0.1 gcm⁻³. The density figure shows that the material has reached the theoretical density with negligible residual porosity after HIP.

Electrical conductivity of billets was measured in the range 25.0 to 27.4 IACS %.

Billets with 75 mm diameter and length of 100 mm were cut for extrusion trials and successfully extruded at a rate of 3 mms⁻¹ through a 15.7 mm diameter die. Micrographs of transverse and longitudinal sections of the extruded material are shown in FIG. 4A and FIG. 4B, where it can be seen that the distribution of SiC is substantially uniform in both sections.

A billet 154 mm in diameter and 154 mm long was forged at a temperature of between 450° C. and 500° C. to a forging reduction ratio of 3:1 at a rate of 15 mms⁻¹. The billet was successfully forged without any surface defects being evident.

### EXAMPLE 2

2 kg of ASP30 steel powder with a maximum particle size of 400 μm was loaded into a glass vessel with a capacity of 4.5 litres. A further 60 g of zirconia (ZrO₂) with a particle size of 1-4 μm was then added to the container, which was then sealed by means of a rubber bung. In total, the powders filled the vessel to approximately 20% of its capacity.

The powder vessel was mounted in the apparatus of Example 1 and the powders were blended for a time of 1 hour, after which time the vessel was removed from the holder. The powder blend was then poured from the can into a mild steel can with diameter of 90 mm. This process was repeated until the can contained the required total weight of blended powder. The can size was determined by the size of the finished component required.

The can and powder blend was then degassed under vacuum and temperature known in the art. The can was then sealed to prevent the ingress of contaminants ready for HIP at a temperature of between 1050° C. and 1250° C. and pressure of 15000 psi (103 MPa).

After HIP the can was removed from the HIP vessel and then the can material was removed to leave a consolidated billet.

U.S. Pat. No. 6,033,789 discloses the manufacture of a cutting tool which has an ASP30 steel core, which is surrounded by a ASP30 steel/zirconia mix. It is within the ambit of this invention to provide a core, such as that disclosed in U.S. Pat. No. 6,033,789 (the entire disclosure of which is incorporated by reference herein), about which a powder blend made in accordance with the invention may be located.

Cutting tools manufactured from the material of Example 2, with or without the use of a core, are found to have a tool life 2 to 3 times greater than an equivalent ASP30 tool.

The mixing vessel could be made of a metal and coated inside with an electrically insulating coating. This could be done, for example, by coating the inside of a steel vessel with glass which would give the vessel more resistance to external damage than would be the case if the vessel were made entirely of glass.

Although the vessel shown is a simple jar shape, the vessel would be as effective if were some other configuration known in powder mixing, for example a Y-Cone.

Although holder 17 is shown as having a principal axis which is mounted perpendicular to the axial direction of the shaft 12, the holder 17 could equally be mounted at some other angle. However, it is considered that the tumbling action would become less efficient as the angle between the shaft 12 and holder 17 reduced, say to less than 45°, because the distance tumbled by the powder in the container would be reduced.

1. A method of mixing two non-identical powder or particulate materials together for the substantially homogeneous distribution of one material within the other, the method comprising locating quantities of each material in an electrically insulating vessel and agitating the vessel for a period of time.

2. A method according to claim 1, wherein the two materials comprise metallic particles and non-metallic particles respectively.

3. A method according to claim 2, wherein the non-metallic particles comprise or consist of ceramic material.

4. A low energy method of mixing metallic and non-metallic particulate materials for the substantially homogeneous distribution of one material throughout the other, the method comprising locating quantities of each material into a vessel comprising an electrically insulating material and agitating the vessel for a period of time

5. A method according to claim 2, wherein the metallic particles are present in a major proportion.

6. A method according to claim 2, comprising agitating the vessel by rotating the vessel.

7. A method according to claim 6, comprising rotating the vessel such that, during at least a part of each rotation, a major axis of the vessel has a vector component in the vertical.

8. A method according to claim 6, comprising rotating the vessel at a speed in the range of 3 to 60 rpm, preferably in the range of 10 to 36 rpm.

9. A method according to claim 6, comprising locating a volume of powder in the vessel which is less than the internal volume of the vessel.

10. A method according claim 6, comprising locating powder within the vessel to fill less than 60% of the internal volume of the vessel.

11. A method of forming a metal matrix composite (MMC) MMC or MMCp material, the method comprising locating quantities of a metal particulate material and a ceramic particulate material in an electrically insulating vessel, agitating the vessel for a period of time to mix the two materials, placing the mixed materials in a deformable vessel and subjecting the vessel to temperature and pressure to consolidate the mixed materials.

12. Apparatus for providing a substantially homogeneous distribution of one particulate material within another, the apparatus comprising a vessel holding means and a vessel having an electrically insulating inner surface in which quantities of each material are locatable, the vessel being retainable by said vessel holding means and the apparatus further comprising means for agitating the vessel for a period of time.

13. The apparatus according to claim 12, wherein the internal surface of the vessel is formed from glass or a polymeric, plastics material.

14. The apparatus according to claim 12, wherein the vessel comprises a metal which is coated inside with an electrically insulating coating.

15. (canceled)

16. (canceled)
